(19) United States
(12) Patent Application Publication
(10) Pub. No.: US 2010/0037971 A1
(43) Pub. Date: Feb. 18, 2010

(54) CONDUIT COVER

(76) Inventors: Glenn J. Scherer, Asbury, NJ (US); Chad C. Schwartz, Washington, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/540,692

(22) Filed: Aug. 13, 2009

Related U.S. Application Data
(60) Provisional application No. 61/188,902, filed on Aug. 14, 2008.

(51) Int. Cl. F16L 55/00; B23P 11/00

(52) U.S. Cl. 138/110; 29/428; 138/156; 138/104

(57) ABSTRACT

Improved conduit covers and methods of making and using same enable the conduits to be located easily and their contents to be readily identified. The covers have a simple construction which allows for inexpensive manufacture and simple and rapid installation over conduits having a wide range of diameters.

### CROSS-REFERENCE TO RELATED APPLICATIONS

The present application claims the benefit of the filing date of U.S. Provisional Application No. 61/188,902, filed Aug. 14, 2008, the disclosure of which is hereby incorporated by reference herein.

### FIELD OF THE INVENTION

The present invention relates to conduit covers used to indicate the contents of utility conduits according to a predetermined color scheme.

### BACKGROUND OF THE INVENTION

Recent proposed codes, for example New York City proposed fire code section FC 504, require that conduits, cable trays and piping be color-coded with continuous, durable, and weatherproof reflective or luminescent markings to facilitate rapid identification under day and night emergency and non-emergency conditions. For example, high voltage wiring may be coded red, low voltage wiring may be coded orange, natural gas piping may be coded yellow, other compressed gas piping may be coded yellow and labeled at regular intervals with the type of gas, fuel oil piping may be coded yellow with black stripes, etc.

However, devices or covers that have been known to date are often complex, requiring interlocking elements and/or multiple components. Known covers can also be difficult or expensive to manufacture and do not provide for the rapid identification of pipes or conduits by emergency or service personnel under both day and night conditions. Thus, there exists a need for improved conduit covers which can be securely attached to a conduit and which provide easy identification of the contents of the conduit in the light and in the dark. Preferably, such conduit covers are readily installed, inexpensively manufactured, easily identified, and require no specialized tools or parts for installation on or removal from a conduit.

### SUMMARY OF THE INVENTION

The present invention addresses these needs.

One aspect of the invention provides a conduit cover for a conduit having a predetermined radius of curvature. The cover includes an elongated body having first and second longitudinal edges, and a radius of curvature which is less than the radius of curvature of the conduit. The body may envelop more than 180 degrees of the conduit when installed on the conduit. The body may be formed by extrusion molding, and may have a color selected from a predetermined series of colors.

The body may be formed from an elastic material. Preferred elastic materials may be selected from the group consisting of ABS, nylon, polycarbonate, polyethylene, polypropylene, polystyrene, polyvinyl chloride, polyurethane and combinations thereof.

Preferably, the body includes at least one coloring agent for imparting a color to the body. The body may also include at least one luminescent material for imparting luminescence to the body, and/or at least one reflective material for imparting a reflective property to the body. The body may also include at least one ultraviolet radiation inhibitor.

In embodiments of the conduit cover according to this aspect of the invention, the body may include an inner layer having a first set of properties and an outer layer having at least one property different from the first set of properties. In some arrangements, the inner layer may include at least one coloring agent for imparting a color to the inner layer, and the outer layer may be substantially transparent or translucent. At least one of the inner layer or the outer layer may include at least one luminescent material for impartment luminescence to the body. Furthermore, at least one of the inner layer or the outer layer may include at least one reflective material for imparting a reflective property to the body. In other arrangements, the outer layer may include at least one coloring agent for imparting a color to the body, and may further include at least one luminescent material for imparting luminescence to the body. The inner and outer layers may be formed by coextrusion. Moreover, the inner layer may be formed from a first polymer and the outer layer may be formed from a second polymer different from the first polymer.

Another aspect of the present invention provides a cover for a conduit, including an elongated body having first and second longitudinal edges and a color selected from a predetermined series of colors.

Yet another aspect of the invention provides a method of making and using a conduit cover. The method includes extruding a body having first and second longitudinal edges and a color selected from a predetermined series of colors; cutting a length of the body sized to fit a length of a conduit; and installing the body on the conduit so that the body envelops more than 180 degrees of the conduit.

Still another aspect of the invention provides another method of making and using a conduit cover. The method includes coextruding inner and outer layers of a body having first and second longitudinal edges, the inner layer having a first set of properties and the outer layer having at least one property different from the first set of properties; cutting a length of the body sized to fit a length of a conduit; and installing the body on the conduit.

A still further aspect of the invention provides a series of conduit covers for installation on a plurality of conduits, at least one of the conduits carrying first contents that are different from the contents carried by others of the conduits. Each of the conduit covers includes an elongated body having first and second longitudinal edges and a color, at least one of the bodies having a first color and others of the bodies having a color different from the first color so that, when the at least one of the bodies is installed on the at least one conduit carrying the first contents and the others of the bodies are installed on the others of the conduits carrying contents different from the first contents, the colors of the bodies represent the contents being carried by the conduits.

Yet a further aspect of the invention provides a series of conduit covers for installation on a plurality of conduits, ones of the conduits carrying contents that are different from the contents carried by others of the conduits. Each of the conduit covers includes an elongated body having first and second longitudinal edges and a color, the color of the body corresponding to the contents of the conduit on which the body is to be installed.

Still a further aspect of the invention provides a method of installing conduit covers on a plurality of conduits, ones of the conduits carrying contents that are different from the contents carried by others of the conduits. The method includes providing a plurality of bodies, each body having first and second longitudinal edges and a color; installing a body having a first color on each of the plurality of conduits carrying first contents; and installing a body having a second color different from the first color on each of the plurality of conduits carrying second contents different from the first contents, whereby the colors of the bodies represent the contents being carried by the conduits.

### BRIEF DESCRIPTION OF THE DRAWINGS

FIG. 1 is a partial perspective view of one embodiment of a conduit cover according to the present invention;

FIG. 2 is a partial perspective view of the conduit cover of FIG. 1 in an assembled position on a conduit;

FIG. 3 is a cross-sectional view taken along line 3-3 of FIG. 2;

FIG. 4 is a partial perspective of a second embodiment of a conduit cover according to the present invention;

FIG. 5 is a cross-sectional view of the conduit cover of FIG. 4 in an assembled position on a conduit;

FIG. 6 is a partial perspective view of a third embodiment of a conduit cover according to the present invention;

FIG. 7 is a cross-sectional view of the conduit cover of FIG. 6 in an assembled position on a conduit;

FIG. 8 is a partial perspective view of a fourth embodiment of a conduit cover according to the present invention; and

FIG. 9 is a cross-sectional view of the conduit cover of FIG. 8 in an assembled position on a conduit.

### DETAILED DESCRIPTION

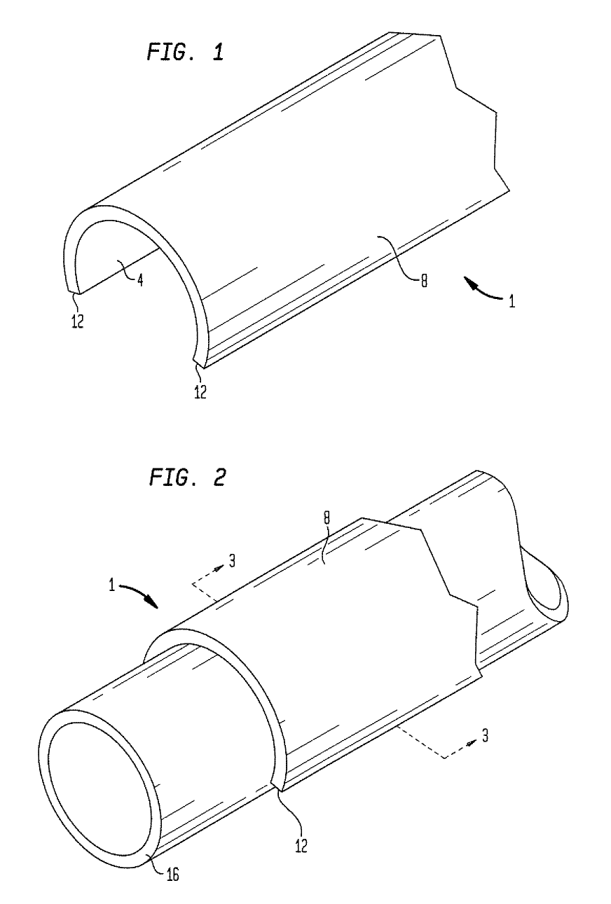

Referring to FIG. 1, a conduit cover 1 according to one embodiment of the present invention can be seen prior to installation on a conduit. Conduit cover 1 has a generally cylindrical shape of indefinite length, with an interior surface 4, an exterior surface 8 and a thickness defined between the interior and exterior surfaces. According to this embodiment, cover 1 forms an incomplete cylinder substantially in the shape of a “C”. That is, the cover has a pair of edges 12 which extend along the length of the cover such that, when cover 1 is assembled on a conduit, edges 12 extend substantially parallel to the longitudinal axis of the conduit.

The degree of resiliency of cover 1 can be adjusted to some extent by adjusting the thickness of the cover. Thus, as will be appreciated from the discussion below regarding the installation of cover 1 on a conduit, depending on the composition of the cover and/or the particular application, the thickness of the cover may be adjusted to provide a sufficient degree of “spring back” to assure that the cover will remain attached to the underlying conduit for the intended design life. Preferably, cover 1 will have a nominal thickness less than about 0.050 inches, and more preferably, less than about 0.025 inches. Still more preferably, the nominal thickness of cover 1 will be between about 0.010 inches and about 0.015 inches.

Cover 1 is preferably formed from a strong elastic material which is capable of flexibly deforming for application to a conduit, and then returning toward its original shape so as to securely engage and hold on to the conduit. Desirably, such material is substantially unaffected by ordinary environmental conditions so that cover 1 retains its properties even when installed out of doors and exposed to the environment for long periods of time. In this regard, preferred materials for forming cover 1 may be selected from the group consisting of thermoplastic materials, thermosetting materials and combinations thereof, including, for example, one or more of ABS, nylon, polycarbonate, polyethylene, polypropylene, polystyrene, polyvinyl chloride, and polyurethane. Unplasticized polyvinyl chloride (uPVC) is particularly preferred.

Additives such as stabilizers, lubricants, surfactants, antioxidants, flame retardants, cross-linking agents and the like may be included to aid in processing the material and/or improving durability or performance. These materials are well known in the art and can be selected by the artisan depending on the particular materials and/or processes used to produce the cover and the applicable design requirements. Additionally, UV stabilizers which are well known in the art may be added to the formulation to impart a specific level of UV radiation resistance in order to minimize degradation of the cover upon exposure to UV radiation, or to meet a specific weatherability or durability requirement.

The cover 1 can be color-coded to any desired identification scheme by the addition of a coloring agent, such as a pigment, ink, paint and/or dye. The coloring agent may be added to the formulation prior to the fabrication of cover 1, or may be added as a distinct coating during or after fabrication of the cover. Furthermore, multiple processes may be used to create two or more color regions on cover 1. For example, exterior surface 8 may be printed with a second color after cover 1 has been formed with a first color to create, for example, a striped pattern or any other desirable combination of colors or patterns on the cover. The color may be distributed homogeneously throughout the thickness of cover 1 or may be contained in one or more layers at or near the exterior surface of the cover. The various coloring agents and combinations of coloring agents used to develop various colors are well known to those skilled in the art.

The cover 1 can also be manufactured to glow in the dark and/or be reflective by the use of one or more luminescent and/or reflective materials. Luminescent materials and reflective materials may be solid particles or liquids of one or more materials that can be dispersed homogeneously throughout the thickness of the cover by mixing the material into the formulation, or alternatively, that can form one or more layers at or near the exterior surface 8 of the cover. In one arrangement, the luminescent and/or reflective materials may be mixed with the coloring agent before being incorporated in the formulation for cover 1 or in one or more layers of the cover. In another arrangement, the luminescent and/or reflective materials may be applied to the surface of cover 1 after fabrication, such as by painting, spraying, dipping or other process.

Any luminescent and/or reflective materials which are compatible with the materials forming cover 1 may be utilized to impart luminescence and/or reflectivity to the cover. Covers 1 fabricated using luminescent materials typically begin with a bright glow which decays over a period of time, generally in 8 to 10 hours. The material can be re-activated to glow by exposure to either artificial or natural light for about one hour. Luminescent and reflective materials having a wide range of glow-in-the-dark and/or reflective characteristics are contemplated herein. Such materials are well known to those skilled in the art.

In addition to color-coding, the use of luminescent and/or reflective materials allows, for example, fire fighters or other emergency personnel to quickly locate conduits and identify their contents even at night when there may be little available light. Preferably, the cover 1 will glow for at least about 4 hours after ordinary exposure to daylight. More preferably, the cover 1 will glow for at least about 8 hours or longer after ordinary exposure to daylight. In addition, the use of reflective materials will enable cover 1 to be easily seen and identified using a flashlight or other portable light.

Cover 1 may be formed without the addition of a coloring agent, such that the resultant cover will have a basic color, such as white, grey, black, or tan, derived from the natural colors of the materials used to form the cover. A predetermined color or color scheme may be applied to the outer surface of cover 1, for example, by painting, spraying, dipping, printing or other coating process. Alternatively, the predetermined color or color scheme may be applied to the cover by adhering a colored tape or film to the outer surface of the cover. Likewise, luminescent and/or reflective materials may be applied by one or more of the processes described above or by the application of a luminescent and/or reflective tape or film to the cover. Where a tape is used, a colored luminescent and/or reflective tape may be applied to the outer surface of the cover to impart both color and a luminescent and/or reflective property to the cover. In addition, a pre-colored cover, that is, a cover containing a coloring agent, may be coated or taped as discussed above to impart a different color or colors, a predetermined pattern, luminescence and/or reflective properties to the cover.

In a preferred arrangement, cover 1 may be formed using an extrusion molding process. Extrusion molding enables cover 1 to be formed with an indefinite length and a substantially uniform cross-sectional thickness along its length. Long lengths of covers of different colors and/or different types and sizes may be produced, coiled, stored, and transported to a job site and easily cut to the required length during installation of the cover over a conduit. Other fabrication methods, such as, for example, injection molding, compression molding, stamping, laminating, and thermoforming, may also be used, as will be apparent to those skilled in the art.

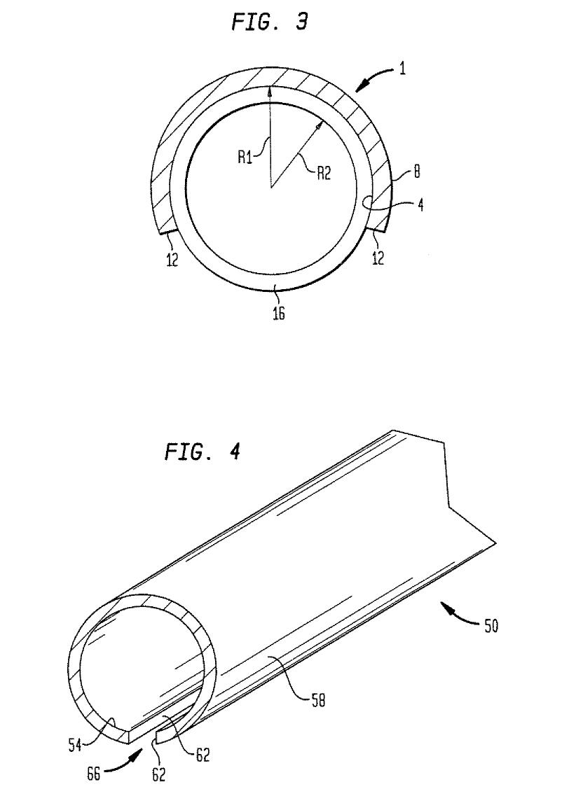

Covers 1 as described above may be installed quickly and easily in various lengths over conduits of various diameters. As shown in FIGS. 2-3, the cover 1 can be installed by pulling longitudinal edges 12 away from one another by an amount sufficient to fit the cover over a conduit 16. Once cover 1 is in place over conduit 16, the edges 12 may be released, whereupon the cover will return toward its relaxed condition. Since cover 1 in the relaxed condition has a smaller radius of curvature R1 than the radius of curvature of conduit 16, the cover will frictionally engage the conduit and remain securely attached thereto in assembled relationship.

After installation on the conduit 16, the cover 1 preferably envelops more than 180 degrees of the conduit. Because the cover 1 is formed from a resilient material, the C-shape can be readily opened to fit over the conduit 16 and will self tighten around the conduit, thus creating a frictional attachment. The cover can also be relatively easily removed and/or replaced by reversing the installation process. That is, by prying apart edges 12, the cover can be removed from the conduit.

It will be appreciated from the foregoing that cover 1 may be used over conduits 16 having a relatively wide range of diameters. However, where the diameter of conduits 16 are too large for proper application of covers 1 having a predetermined diameter in the relaxed condition, covers 1 having a larger diameter in the relaxed condition may be used. Similarly, where the diameters of conduits 16 are too small for covers 1 having a predetermined diameter to frictionally engage thereon, covers 1 having a smaller diameter in the relaxed condition may be used. Hence, conduits 16 having a wide range of diameters may be accommodated by providing covers 1 with a limited number of predetermined diameters in the relaxed condition.

As a result of the C-shape of cover 1, the cover may be installed on conduits 16 even where the conduit is mounted to a building or other structure at periodic mounting points, such as by use of brackets or the like, provided the brackets only attach to one side of the conduit so as not to interfere with the cover. In such situations, the brackets will lie in the gap between the longitudinal edges 12 of the cover in the assembled position. However, where the mounting brackets surround the conduit 16 or would otherwise interfere with the installation of the cover 1, the cover can be cut to a length which fits on the conduit between the brackets. Also, in the event that conduit 16 is mounted in a depression such that access to the underside of the conduit is limited, cover 1 may be securely assembled on the conduit without the need to access the underside of the conduit. Thus, cover 1 is capable of installation in a wide variety of mounting schemes.

In a variant of the foregoing, cover 1 may be held to conduit 16 by a series of mechanical fasteners, for example, clamps, brackets, zip-ties and the like. It will be appreciated that where such mechanical fasteners are used, cover 1 may envelop less than 180 degrees of conduit 16 when installed thereon. In a preferred arrangement according to this variant, cover 1 may be applied to conduit 16 prior to or during installation of the conduit itself such that the mounting hardware for the conduit may also serve to secure the cover to the conduit. Alternatively, cover 1 may be secured to conduit 16 by an adhesive before or after installation of the conduit. An adhesive may be used to assure a secure attachment of cover 1 to conduit 16 regardless of whether the cover envelops more or less than 180 degrees of the conduit.

A conduit cover 50 in accordance with another embodiment of the present invention is shown in FIG. 4 prior to installation on a conduit. Conduit cover 50 has a generally cylindrical shape of indefinite length, with an interior surface 54, an exterior surface 58 and a thickness defined between the interior and exterior surfaces. Cover 50 is substantially similar to cover 1 described above. However, in this embodiment, the longitudinal edges 62 of the cover are much closer together than the longitudinal edges 12 of cover 1 such that cover 50 forms a nearly complete cylinder.

As with cover 1, the degree of resiliency of cover 50 can be adjusted by adjusting the thickness of the cover based on a particular application and/or cover composition to assure that the cover will remain attached to the underlying conduit for the intended design life. Preferably, cover 50 will have a nominal thickness of less than about 0.050 inches, and more preferably, less than about 0.025 inches. A nominal thickness for cover 50 of between about 0.010 inches and about 0.015 inches is highly preferred.

Cover 50 may be formed from the same materials, including the coloring agents, luminescent materials and reflective materials, as are described above for forming cover 1. Cover 50 may also be fabricated using the same processes as are used to fabricate cover 1, including, for example, extrusion and injection molding. In this regard, cover 50 may be molded to its final configuration having a slit 66 between longitudinal edges 62. Alternatively, cover 50 may be molded in the configuration of a complete cylinder and subsequently cut longitudinally to form edges 62.

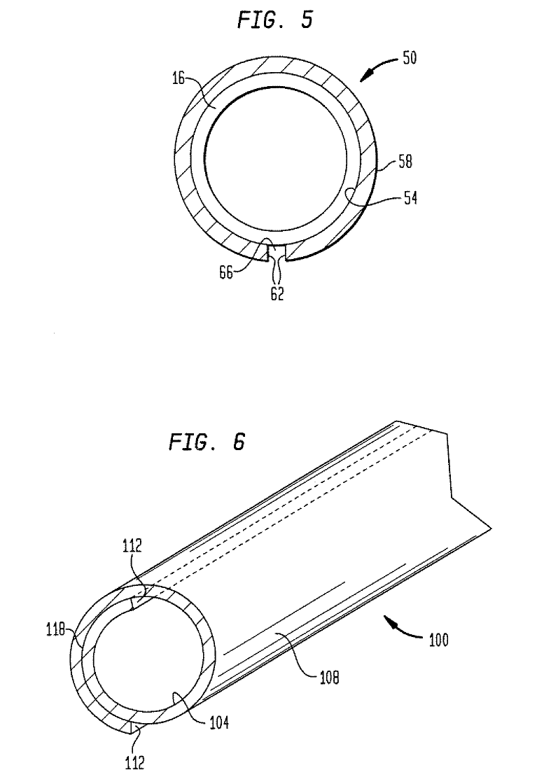

Cover 50 may be installed on a conduit 16 in the same manner or manners as cover 1 described above. Thus, for example, edges 62 of cover 50 may be pulled away from one another by an amount sufficient to fit the cover over the conduit. As edges 62 are released, the elasticity of the cover will cause the edges 62 to move toward one another as the cover frictionally engages the conduit, as shown in FIG. 5. Desirably, in its assembled position, cover 50 envelops more than 270 degrees of the conduit 16. Preferably, cover 50 envelops between about 270 degrees and about 360 degrees of the conduit such that edges 62 are substantially proximate one another. In such an arrangement, little to no gap may be formed between edges 62 and the conduit 16 may be enveloped substantially completely.

As will be appreciated, the configuration of cover 50 allows for the cover to be fit over a wider range of conduit diameters than cover 1, thus reducing cost, installation time and the need for multiple cover diameters. Selection of a cover diameter which can be expanded to fit over one or more conduits having different diameters will be apparent to one skilled in the art.

A conduit cover 100 in accordance with yet another embodiment of the present invention is shown in FIG. 6 prior to installation on a conduit. Conduit cover 100 has a generally cylindrical shape of indefinite length, with an interior surface 104, an exterior surface 108 and a thickness defined between the interior and exterior surfaces. Cover 100 is similar to covers 1 and 50 described above, but rather than forming a C-shape or the shape of a complete or nearly complete cylinder, cover 100 forms an overlapping cylinder. That is, the longitudinal edges 112 of cover 100 overlap with the interior and exterior surfaces 104 and 108, respectively, so as to form a helical or spiral structure.

As with covers 1 and 50, the degree of resiliency of cover 100 may be adjusted by adjusting the thickness of the cover based on a particular application and/or cover composition to assure that the cover will remain attached to the underlying conduit for the intended design life. Preferably, cover 100 will have a nominal thickness of less than about 0.050 inches, and more preferably, less than about inches. A nominal thickness for cover 100 of between about 0.010 inches and about 0.015 inches is highly preferred.

Cover 100 may be formed from the same materials, including the coloring agents, luminescent materials and reflective materials, as are described above for forming covers 1 and 50. Cover 100 may also be fabricated using the same processes as are used to fabricate covers 1 and 50, including, for example, extrusion and injection molding.

Preferably, cover 100 is formed from a material which is readily adapted to extrusion molding processes. Extrusion molding enables cover 100 to be formed in an indefinite length and a substantially uniform cross-sectional thickness along its length. The cover 100 may be made as a complete cylinder and longitudinally slit to form longitudinal edges 112, or may be molded to include edges 112 without the need for subsequent processing. After molding, and where applicable, slitting, cover 100 may self coil such that edges 112 overlap one another. Optionally, subsequent processing may be employed, such as heating and rolling, to form the coiled shape.

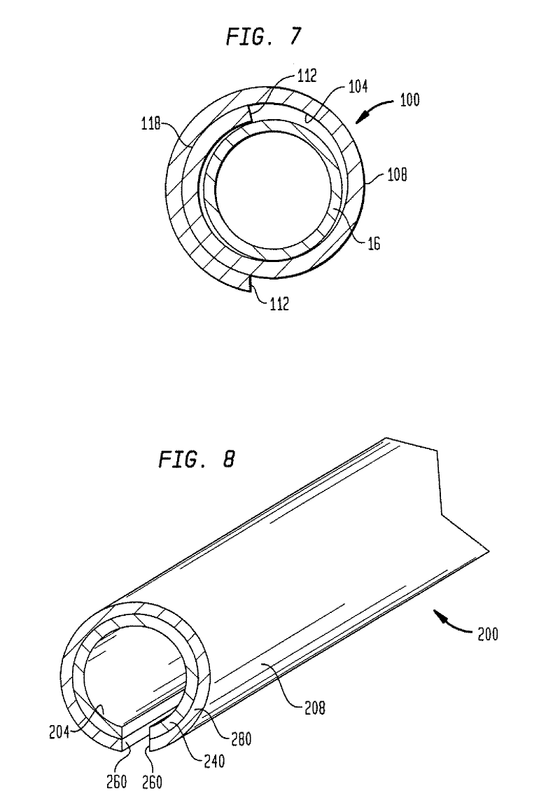

Cover 100 may be installed on a conduit 16 in substantially the same manner as covers 1 and 50 described above. That is, edges 112 of cover 100 may be pulled away from one another by an amount sufficient to fit the cover over the conduit. As edges 112 are released, the elasticity of the cover will cause the edges 112 to move toward and past one another as the cover frictionally engages the conduit, as shown in FIG. 7. Cover 100 may envelop the entirety of conduit 16 as it overlaps itself. In this assembled position, overlap region 118 may be formed between outer surface 108 and inner surface 104 of the cover in the region between edges 112. Preferably, cover 100 overlaps itself by at least about 5 degrees when installed on a conduit, and more preferably by between about 5 degrees and about 180 degrees. That is, cover 100 may envelop the conduit by between about 365 degrees and about 540 degrees. Of course, when cover 100 is installed on a conduit, any size overlap is contemplated.

As will be appreciated, the configuration of cover 100 allows for the cover to be fit over a much wider range of conduit diameters than covers 1 or 50, thus further reducing cost, installation time and the need for covers of multiple diameters. Moreover, by overlapping itself in the assembled position on conduit 16, cover 100 provides a particularly strong connection to the conduit in those applications where detachment of the cover from the conduit is more likely, or where such detachment could be particularly problematic. Selection of a cover diameter which can be expanded to fit over one or more conduits having different diameters will be apparent to one skilled in the art.

A conduit cover 200 in accordance with still another embodiment of the present invention is shown in FIG. 8 prior to installation on a conduit. Conduit cover 200 has a generally cylindrical shape of indefinite length, with an interior surface 204, an exterior surface 208, a thickness defined between the interior and exterior surfaces, and longitudinal edges 260.

Cover 200 is similar to covers 1, 50 and 100 described above, but is formed with at least two layers, including an inner layer 240 and an outer layer 280. The inner layer 240, the outer layer 280 or both layers may include one or more coloring agents so that cover 200 is colored, and optionally may include one or more luminescent materials and/or reflective materials so that the cover 200 can be easily located in the dark as discussed above. Preferably, at least one coloring agent and any luminescent and/or reflective materials are included in inner layer 240, and outer layer 280 is transparent or translucent. Still more preferably, the outer layer 280 includes at least one UV radiation inhibitor. It is also contemplated that UV radiation inhibitors may be added to the inner layer or to both layers.

As will be appreciated, the configuration of cover 200 allows for protection of the inner layer 240 by the protective outer layer 280, thus reducing color fading, degradation of glow-in-the-dark and/or reflective properties, and physical damage to the inner layer. Thus, cover 200 has increased durability, particularly when the cover is installed out of doors.

As with covers 1, 50, and 100, the degree of resiliency of cover 200 can be adjusted by adjusting the thickness of the cover based on a particular application and/or cover composition to assure that the cover will remain attached to the underlying conduit for the intended design life. Preferably, cover 200 will have a nominal thickness of less than about 0.050 inches, and more preferably, less than about 0.025 inches. A nominal thickness for cover 200 of between about 0.010 inches and about 0.015 inches is highly preferred.

Cover 200 may be formed from the same materials, including the coloring agents, luminescent materials and reflective materials, as described above. Cover 200 may also be fabricated using the same processes as are used to fabricate covers 1, 50 and 100, including, for example, extrusion and injection molding. In this regard, cover 200 may be formed in a two-step process in which one of the layers 240 and 280 is molded first followed by the molding of the second layer so that the layers bond to one another. Alternatively, layers 240 and 280 may be formed in separate processes and then joined to one another by any of a number of well known techniques.

Preferably, cover 200 is fabricated by a coextrusion process. In such process, the cover may be coextruded to simultaneously produce an inner colored, glow-in-the-dark and/or reflective layer and an outer translucent or transparent UV radiation protective layer. The inner layer 240 and outer layer 280 may be intimately bonded to one another as a result of the coextrusion process. As will be appreciated, coextrusion may be used to fabricate conduit covers 200 having two or more layers. Each layer may have similar or different properties. For example, each layer may be fabricated with the same or different materials, colors, reflective properties, luminescence, UV radiation resistance, and mechanical properties such as strength, stiffness and resiliency. As described above, coextrusion may be utilized to produce a colored luminescent and/or reflective inner layer and a translucent or transparent UV protective outer layer during a single molding operation.

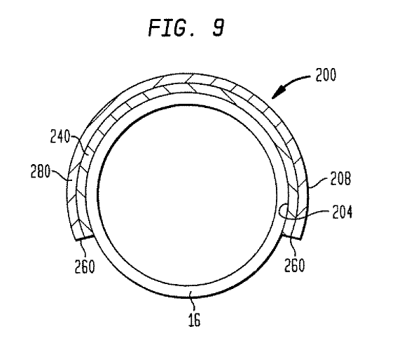

Cover 200 may be installed on a conduit 16 in substantially the same manner as covers 1, 50 and 100 described above. Edges 260 of cover 200 may be pulled away from one another by an amount sufficient to fit the cover over the conduit. As edges 260 are released, the elasticity of the cover will cause the edges 260 to move toward one another as the cover frictionally engages the conduit, as shown in FIG. 9.

It will be appreciated that the two-layer structure of cover 200 can be used to form any of the cover configurations described above, such as the C-shape of cover 1, the nearly complete cylinder of cover 50 or the overlapping cylinder of cover 100. Preferably, cover 200 engages more than 180 degrees of the diameter of conduit 16 so as to provide a secure connection thereto. Of course, when cover 200 is installed on a conduit, any amount of overlap of the surfaces 204, 208 of the cover, as with cover 100, or any size gap between the longitudinal edges 260 of the cover, is contemplated. It will be further appreciated that one size of conduit cover 200 can be used to fit a variety of different conduit sizes and mounting configurations similar to covers 1, 50 and 100, thus also reducing cost and increasing the efficiency of cover installation.

Although the covers of the present invention have been described in connection with their installation around utility conduits for indicating the contents of the conduits, they similarly may be assembled around exposed wires and/or cables (i.e., wires and cables which are not installed inside of a conduit) so as to indicate the type of wire or cable and readily identify its location. Moreover, it will be appreciated that the covers of the present invention may be assembled over conduits 16 which do not have a round cross-section. Thus, because of their elastic properties, the covers of the present invention may be assembled over conduits, cable raceways and other structures having a square, rectangular or other cross-sectional shape.

In addition to locating and identifying utility conduits, cables and the like, the covers of the present invention may be applied to other structures so that the structures can be quickly located when needed. For example, the covers of the present invention may be wrapped around hand rails in a building's egress stairway so that they can be readily located by occupants fleeing the building in an emergency situation.

Numerous variations and combinations of the features discussed above can be utilized without departing from the present invention as defined by the claims. Thus, the particular features, structures, materials or characteristics discussed above in connection with any one or more embodiments may be combined in any suitable manner to form other embodiments not expressly described herein.

Although the invention herein has been described with reference to particular embodiments, it is to be understood that these embodiments are merely illustrative of the principles and applications of the present invention. For example, the present invention is not limited to any particular size or geometry of conduit cover. It is therefore to be understood that numerous modifications may be made to the illustrative embodiments and that other arrangements may be devised without departing from the spirit and scope of the present invention as defined by the appended claims.

1. A conduit cover for a conduit having a predetermined radius of curvature, the cover comprising:
an elongated body having first and second longitudinal edges, the body having a radius of curvature which is less than the radius of curvature of the conduit and enveloping more than 180 degrees of the conduit when installed on the conduit.

2. The conduit cover of claim 1, wherein the body is formed from an elastic material.

3. The conduit cover of claim 2, wherein the elastic material is selected from the group consisting of ABS, nylon, polycarbonate, polyethylene, polypropylene, polystyrene, PVC, polyurethane and combinations thereof.

4. The conduit cover of claim 1, wherein the body has a nominal thickness of less than about 0.025 inches.

5. The conduit cover of claim 4, wherein the nominal thickness is between about 0.010 inches and about 0.015 inches.

6. The conduit cover of claim 1, wherein the body includes at least one coloring agent for imparting a color to the body.

7. The conduit cover of claim 6, wherein the body includes at least one luminescent material for imparting luminescence to the body.

8. The conduit cover of claim 6, wherein the body includes least one reflective material for imparting a reflective property to the body.

9. The conduit cover of claim 6, wherein the body includes at least one ultra-violet radiation inhibitor.

10. The conduit cover of claim 1, wherein the body has a color selected from a predetermined series of colors.

11. The conduit cover of claim 1, wherein the body is produced by extrusion molding.

12. The conduit cover of claim 1, wherein the body includes an inner layer having a first set of properties and an outer layer having at least one property different from the first set of properties.

13. The conduit cover of claim 12, wherein the inner layer includes at least one coloring agent for imparting a color to the inner layer, and the outer layer is substantially transparent or translucent.

14. The conduit cover of claim 12, wherein at least one of the inner layer or the outer layer includes at least one luminescent material for imparting luminescence to the body.

15. The conduit cover of claim 12, wherein at least one of the inner layer or the outer layer includes at least one reflective material for imparting a reflective property to the body.

16. The conduit cover of claim 12, wherein the outer layer includes at least one coloring agent for imparting a color to the body.

17. The conduit cover of claim 16, wherein the outer layer includes at least one luminescent material for imparting luminescence to the body.

18. The conduit cover of claim 12, wherein the inner layer and the outer layer are formed by co-extrusion.

19. The conduit cover of claim 12, wherein the inner layer is formed from a first polymer and the outer layer is formed from a second polymer different from the first polymer.

20. A cover for a conduit, comprising:
an elongated body having first and second longitudinal edges, and a color selected from a predetermined series of colors.

21. A method of making and using a conduit cover, the method comprising:
a) extruding a body having first and second longitudinal edges and a color selected from a predetermined series of colors;
b) cutting a length of the body sized to fit a length of a conduit; and
c) installing the body on the conduit so that the body envelops more than 180 degrees of the conduit.

22. A method of making and using a conduit cover, the method comprising:
a) coextruding inner and outer layers of a body having first and second longitudinal edges, the inner layer having a first set of properties and the outer layer having at least one property different from the first set of properties;
b) cutting a length of the body sized to fit a length of a conduit; and
c) installing the body on the conduit.

23. A series of conduit covers for installation on a plurality of conduits, at least one of the conduits carrying first contents that are different from the contents carried by others of the conduits, each of the conduit covers comprising:
an elongated body having first and second longitudinal edges and a color, at least one of the bodies having a first color and others of the bodies having a color different from the first color so that, when the at least one of the bodies is installed on the at least one conduit carrying the first contents and the others of the bodies are installed on the others of the conduits carrying contents different from the first contents, the colors of the bodies represent the contents being carried by the conduits.

24. A series of conduit covers for installation on a plurality of conduits, ones of the conduits carrying contents that are different from the contents carried by others of the conduits, each of the conduit covers comprising:
an elongated body having first and second longitudinal edges and a color, the color of the body corresponding to the contents of the conduit on which the body is to be installed.

25. A method of installing conduit covers on a plurality of conduits, ones of the conduits carrying contents that are different from the contents carried by others of the conduits, the method comprising:
a) providing a plurality of bodies, each body having first and second longitudinal edges and a color;
b) installing a body having a first color on each of the plurality of conduits carrying first contents; and
c) installing a body having a second color different from the first color on each of the plurality of conduits carrying second contents different from the first contents, whereby the colors of the bodies represent the contents being carried by the conduits.

26. A series of conduit covers for installation on a plurality of conduits, at least one of the conduits carrying first contents that are different from the contents carried by others of the conduits, each of the conduit covers comprising:
an elongated body having first and second longitudinal edges and a color selected from a predetermined series of colors, the body having a radius of curvature which is less than the radius of curvature of the conduit and enveloping more than 180 degrees of a conduit when installed on the conduit;
the body including at least one luminescent material for imparting luminescence to the body, at least one reflective material for imparting a reflective property to the body, and at least one ultra-violet radiation inhibitor;
the body being formed from an elastic material selected from the group consisting of ABS, nylon, polycarbonate, polyethylene, polypropylene, polystyrene, PVC, polyurethane and combinations thereof;
the body having a nominal thickness of between about 0.10 inches and 0.15 inches; and
at least one of the bodies having a first color and others of the bodies having a color different from the first color so that, when the at least one body is installed on the at least one conduit carrying the first contents and the other bodies are installed on the other conduits carrying contents different from the first contents, the colors of the bodies represent the contents being carried by the conduits.
